(19) United States
(12) Patent Application Publication
(10) Pub. No.: US 2024/0069180 A1
(43) Pub. Date: Feb. 29, 2024

(54) OPTICAL AXIS ADJUSTMENT METHOD, LASER RADAR DEVICE, AND OPTICAL AXIS ADJUSTMENT SYSTEM

(71) Applicant: DENSO CORPORATION, Kariya-city (JP)

(72) Inventor: Akira OGAWA, Kariya-city (JP)

(21) Appl. No.: 18/502,567

(22) Filed: Nov. 6, 2023

Related U.S. Application Data
(63) Continuation of application No. PCT/JP2022/015288, filed on Mar. 29, 2022.

(30) Foreign Application Priority Data
Jun. 23, 2021 (JP) 2021-103908

(51) Int. Cl. G01S 7/497

(52) U.S. Cl. CPC G01S 7/4972

(57) ABSTRACT

An optical axis adjustment method for adjusting an optical axis direction of a laser radar device includes irradiating, detecting, and adjusting. The irradiating is irradiating an object with laser light emitted from the laser radar device by controlling the laser radar device to cause a difference in brightness in each of different portions of the object. The detecting is the detecting a center of an irradiation area on the object irradiated with the laser light based on the difference in brightness of each of the different portions of the object irradiated with the laser light emitted from the laser radar device. The adjusting is adjusting the optical axis direction of the laser radar device such that the center detected in the detecting is at a predetermined position relative to the laser radar device.

### CROSS REFERENCE TO RELATED APPLICATIONS

The present application is a continuation application of International Patent Application No. PCT/JP2022/015288 filed on Mar. 29, 2022, which designated the U.S. and claims the benefit of priority from Japanese Patent Application No. 2021-103908 filed on Jun. 23, 2021. The entire disclosures of all of the above applications are incorporated herein by reference.

### TECHNICAL FIELD

The present disclosure relates to an optical axis adjustment method, a laser radar device, and an optical axis adjustment system.

### BACKGROUND

A laser radar device adjusts an optical axis.

### SUMMARY

According to at least one embodiment, an optical axis adjustment method for adjusting an optical axis direction of a laser radar device includes irradiating, detecting, and adjusting. The irradiating is irradiating an object with laser light emitted from the laser radar device by controlling the laser radar device to cause a difference in brightness in each of different portions of the object. The detecting is the detecting a center of an irradiation area on the object irradiated with the laser light based on the difference in brightness of each of the different portions of the object irradiated with the laser light emitted from the laser radar device. The adjusting is adjusting the optical axis direction of the laser radar device such that the center detected in the detecting is at a predetermined position relative to the laser radar device.

### BRIEF DESCRIPTION OF DRAWINGS

The details of one or more embodiments are set forth in the accompanying drawings and the description below. Other features and advantages will be apparent from the description and drawings, and from the claims.

The above and other objects, features and advantages of the present disclosure will become more apparent from the following detailed description made with reference to the accompanying drawings. In the drawings:

FIG. 1 is an explanatory diagram illustrating an outline of a configuration of a laser radar device according to a first embodiment;

FIG. 2 is a flowchart illustrating an example of an optical axis adjustment process;

FIG. 3 is an explanatory diagram illustrating an example of a difference in brightness of a screen detected by a detection unit;

FIG. 4 is an explanatory diagram illustrating a difference in brightness of a screen in a first irradiation state;

FIG. 5 is an explanatory diagram illustrating a difference in brightness of a screen in a second irradiation state;

FIG. 6 is a graph showing brightness of a screen;

FIG. 7 is an explanatory diagram illustrating an outline of a configuration of a laser radar device according to a second embodiment, and

FIG. 8 is an explanatory diagram illustrating an outline of a configuration of an optical axis adjustment system.

### DETAILED DESCRIPTION

To begin with, examples of relevant techniques will be described.

In a laser radar device according to a comparative example, techniques for adjusting an optical axis direction of a laser are known. In the comparative example, adjusting an optical axis in a direction in which intensity of laser light is maximized based on the intensity of the laser light.

However, in order to search for a direction in which intensity laser light is maximized, a large device capable of covering an entire irradiation area is required when the irradiation area of a laser radar device is large. Therefore, a different optical axis adjustment technique was desired.

According to one aspect of the present disclosure, an optical axis adjustment method for adjusting an optical axis direction of a laser radar device includes irradiating, detecting, and adjusting. The irradiating is irradiating an object with laser light emitted from the laser radar device by controlling the laser radar device to cause a difference in brightness in each of different portions of the object. The detecting is the detecting a center of an irradiation area on the object irradiated with the laser light based on the difference in brightness of each of the different portions of the object irradiated with the laser light emitted from the laser radar device. The adjusting is adjusting the optical axis direction of the laser radar device such that the center detected in the detecting is at a predetermined position relative to the laser radar device.

According to the optical axis adjustment method of this aspect, since the optical axis adjustment is performed such that the center of the irradiation area of on the object irradiated with the laser light detected based on the difference in brightness of each of the different portions is at the predetermined position, it is not necessary to capture the entire irradiation area of on the object irradiated with the laser light at the same time. Therefore, the optical axis can be adjusted without using a large-scale apparatus.

### A. First Embodiment

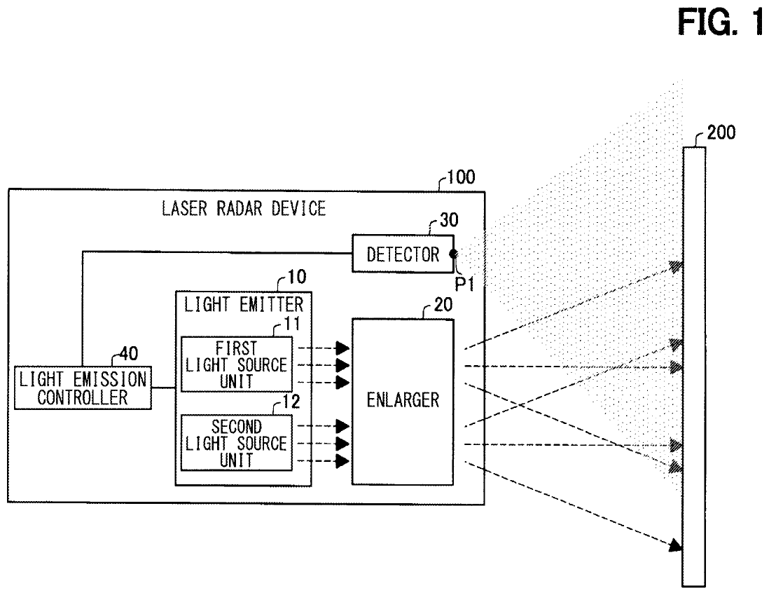

As shown in FIG. 1, a laser radar device 100 (laser radar) includes a light emitter 10, an enlarger 20, a detector 30, and a light emission controller 40. The laser radar device 100 is, for example, a light detection and ranging (LiDAR) mounted on a vehicle. The laser radar device 100 detects surrounding objects as three-dimensional coordinates.

The light emitter 10 emits laser light. In the present embodiment, the light emitter 10 includes light source units arranged in one direction, and emits a line beam. More specifically, the light emitter 10 includes a first light source unit 11 and a second light source unit 12 arranged in a vertical direction. In the present embodiment, the light emitter 10 emits laser light toward a screen 200 installed in front of the laser radar device 100.

The enlarger 20 enlarges a beam diameter of the laser light emitted by the light emitter 10. In the present embodiment, the enlarger 20 irradiates the screen 200 with the laser light emitted by the light emitter 10.

The detector 30 detects brightness of each of different portions of an object from which the laser light enlarged by the enlarger 20 is emitted. The detector 30 is, for example, an infrared camera. In the present embodiment, the detector 30 detects the brightness of each of the different portions of the screen 200. The detector 30 may detect an area including a position estimated to be a center of an irradiation area of on the screen 200 irradiated with the laser light, and may not detect an entire screen 200 at the same time. In the present embodiment, a size in the vertical direction in a detection area of the detector 30 is smaller than a size in the vertical direction of the screen 200.

The light emission controller 40 controls the light emitter 10 to cause a difference in the brightness in each of the different portions of the object irradiated with the laser light emitted from the light emitter 10. In addition, the light emission controller 40 detects the center of the irradiation area of the laser light transmitted from the laser radar device 100 based on the difference in brightness of each of the different portions of the screen 200 detected by the detector 30. Further, an optical axis direction of the laser radar device 100 is adjusted such that the detected center is at a predetermined position. The predetermined position is, for example, the center of the detection area of the detector 30. Details of the detection of the center and the adjustment of the optical axis direction will be described later.

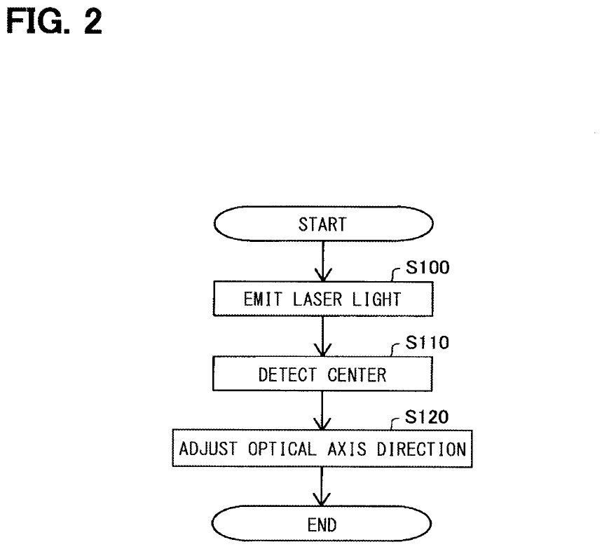

An optical axis adjustment process shown in FIG. 2 is a process of adjusting the optical axis direction of the laser radar device 100. This process is performed, for example, when the laser radar device 100 is manufactured.

In step S100, the light emission controller 40 controls the light emitter 10 such that the brightness of each of different the portions of the object irradiated with the laser light emitted from the light emitter 10 is different. This step is also referred to as an “irradiation step or irradiating”. In the present embodiment, the light emission controller 40 controls the light emitter 10 to emit the laser light while switching between irradiation of the laser light in a part of the irradiation area of the laser light and non-irradiation of the laser light in at least another part of the irradiation area of the laser light, and non-irradiation of the laser light in a part of the irradiation area of the laser light and irradiation of the laser light in at least another part of the irradiation area of the laser light. More specifically, the light emission controller 40 controls the light emitter 10 to emit the laser light from the first light source unit 11 and not to emit the laser light from the second light source unit 12. In the present embodiment, this irradiation state is also referred to as a “first irradiation state”. In addition, the light emission controller 40 controls the light emitter 10 to emit the laser light from the second light source unit 12 and not to emit the laser light from the first light source unit 11. In the present embodiment, the irradiation state different from the first irradiation state is also referred to as a “second irradiation state”.

In step S110, the light emission controller 40 detects the center based on the difference in brightness of each of the different portions of the screen 200 detected by the detector 30. This step is also referred to as a “center detection step or detecting”. In the present embodiment, the light emission controller 40 detects the center based on the difference between the brightness of each of the different portions of the screen 200 when the first light source unit 11 emits the laser light and the second light source unit 12 does not emit the laser light in the first irradiation state and the brightness of each of the different portions of the screen 200 when the second light source unit 12 emits the laser light and the first light source unit 11 does not emit the laser light in the second irradiation state.

In step S120, the light emission controller 40 adjusts the optical axis direction such that the center detected in step S110 is located at a predetermined position. This step is also referred to as an “optical axis adjustment step or adjusting”. In step S120, the light emission controller 40 may adjust an inclination of the laser light emitted by the light emitter 10 and a thickness of the laser light.

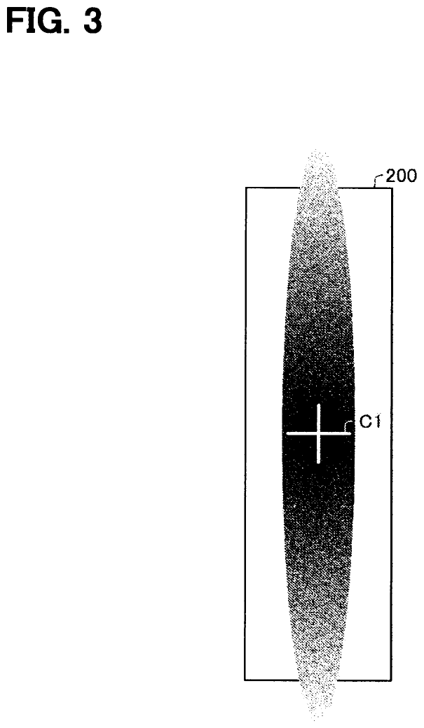

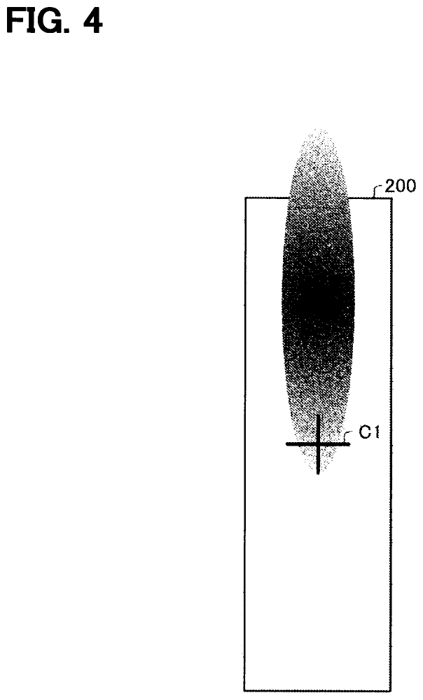

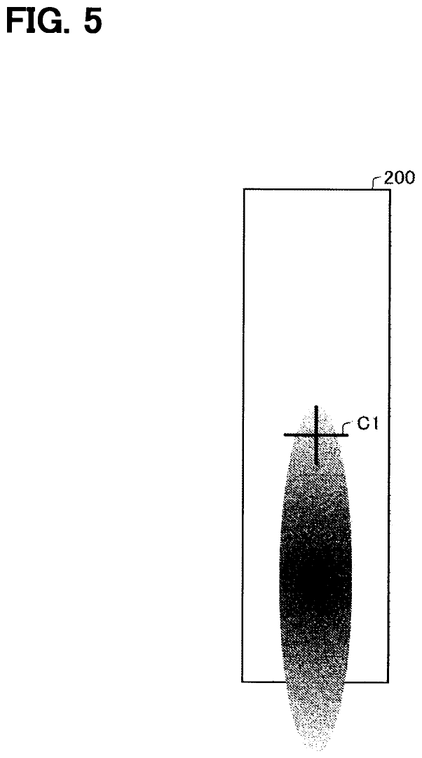

In a front view of the screen 200 detected by the detector 30 shown in FIGS. 3, 4, and 5, a brighter portion is represented by black, and a darker portion is represented by white. A center C1 indicates the center of the irradiation area of the laser light. As shown in FIG. 3, when the first light source unit 11 and the second light source unit 12 irradiate the laser light together, the entire screen 200 including an upper part and a lower part is irradiated. As shown in FIG. 4, in the first irradiation state in which the laser light is irradiated from the first light source unit 11 and the laser light is not irradiated from the second light source unit 12, the upper part of the screen 200 is irradiated. As shown in FIG. 5, in the second irradiation state in which the laser light is irradiated from the second light source unit 12 and the laser light is not irradiated from the first light source unit 11, the lower part of the screen 200 is irradiated.

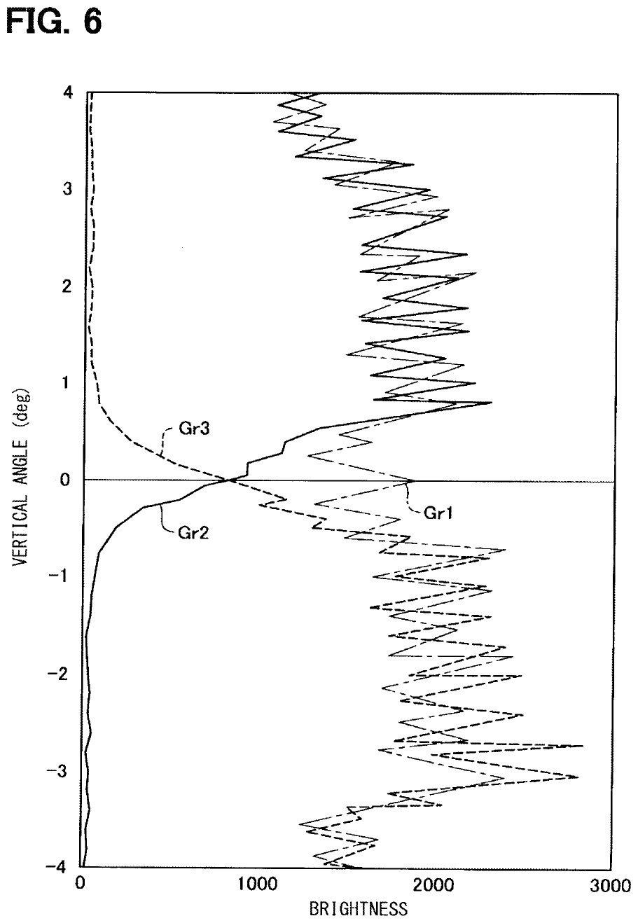

A horizontal axis of a graph shown in FIG. 6 indicates brightness. On a vertical axis of the graph, an angle of each position upward in the vertical direction relative to the center C1 is represented by a positive value, and an angle of each position downward in the vertical direction relative to the center C1 is represented by a negative value, with a case where the center C1 of the irradiation area of the laser light is viewed from a center point P1 (see FIG. 1) of the detector 30 being 0 degrees. A first line Gr1 indicates the brightness of the screen 200 in the case where the first light source unit 11 and the second light source unit 12 irradiates the laser light together, a second line Gr2 indicates the brightness of the screen 200 in the first irradiation state, and a third line Gr3 indicates the brightness of the screen 200 in the second irradiation state. At the center C1, the second line Gr2 and the third line Gr3 intersect with each other. Therefore, in the center detection step described above, the light emission controller 40 detects, as the center of the irradiation area of the laser light, a position that is any one point in the vertical direction and at which the luminance in the portion where the brightness of the screen 200 in the first irradiation state increases is equal to the luminance in the portion where the brightness of the screen 200 in the second irradiation state increases.

According to the laser radar device 100 of the present embodiment described above, since the optical axis adjustment is performed such that the center C1 of the irradiation area of the laser light detected based on the difference in brightness of each of the different portions of the screen 200 which is the object irradiated with the laser light is at the predetermined position, it is not necessary to capture the entire irradiation area of the laser light at the same time. Therefore, the optical axis can be adjusted without using a large-scale apparatus.

In the present embodiment, the light emission controller 40 switches between irradiation and non-irradiation of a part of the laser light and at least another part in the irradiation step. Therefore, even in the light emitter 10 in which a brightness distribution in the irradiation area of the laser light is uniform, a difference in brightness of each of the different portions of the irradiated object can be caused without changing the emission intensity of the laser light. Therefore, the center of the irradiation area of the laser light can be easily detected.

### B. Second Embodiment

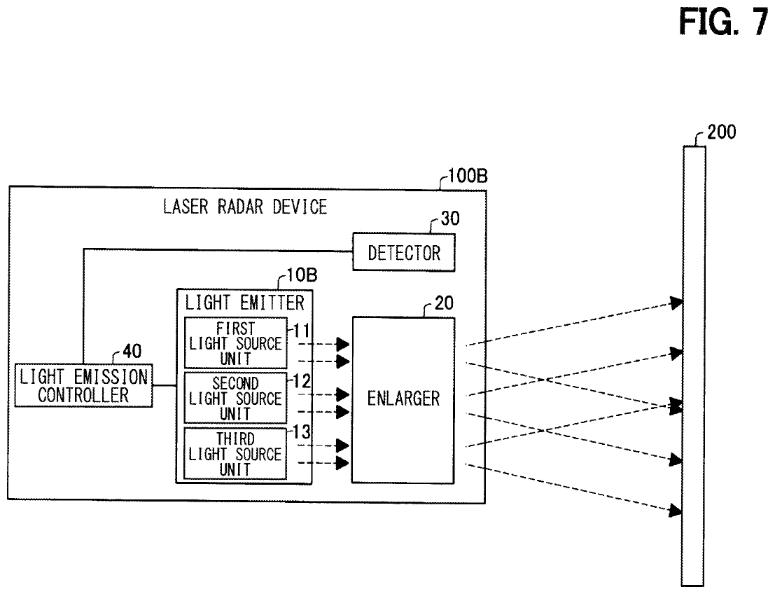

A second embodiment is different from the first embodiment in which a light emission controller 40 controls emission intensity of laser light to control a transmission of the laser light to cause a difference the brightness of each of different portions of an object irradiated with the laser light. As shown in FIG. 7, a light emitter 10 includes a first light source unit 11, a second light source unit 12, and a third light source unit 13. Since the other configuration of the laser radar device 100 of the second embodiment is the same as the configuration of the laser radar device 100 of the first embodiment, the description of the other configuration of the laser radar device 100 is omitted.

The light emission controller 40 controls the light emitter 10 to emit the laser light such that the irradiation area of the laser light includes a portion in which the light emission intensity of the laser light is a first light emission intensity and a portion in which the light emission intensity of the laser light is a second light emission intensity different from the first light emission intensity, thereby causing a difference in the brightness of each of the different portions of the object. In the present embodiment, the first emission intensity is greater than the second emission intensity. More specifically, the light emission controller 40 controls the light emitter 10 to emit the laser light having the first light emission intensity from the first light source unit 11 and the third light source unit 13 and to emit the laser light having the second light emission intensity from the second light source unit 12.

According to the laser radar device 100B of the present embodiment described above, the light emission controller 40 is capable of causing a difference in brightness of each of the different portions of the object irradiated with the laser light by controlling the light emission intensity of the laser light. Therefore, the center of the irradiation area of the laser light can be detected without switching the irradiation state of the laser light.

### C. Third Embodiment

A third embodiment is different from the second embodiment in which laser light is transmitted using only a part of light source units that irradiate the laser light to an area located at the center of the area in which three or more light source units are arranged in one direction. Since the configuration of the laser radar device of the third embodiment is the same as the configuration of the laser radar device of the second embodiment, the description of the configuration of the laser radar device will be omitted.

In the present embodiment, in step S100 (see FIG. 2) of the optical axis adjustment process, the light emission controller 40 transmits the laser light by using a part of the light source units that irradiates the laser light to the area located at the center of the area in which three or more light source units are arranged in one direction and without using the light source units that irradiate the laser light to the other part of the area located at the end of the area in which three or more light source units are arranged in one direction. More specifically, the second light source unit 12 is used, and the laser light is transmitted without using the first light source unit 11 and the third light source unit 13.

When the laser radar device includes three or more light source units arranged in one direction, the center of the irradiation range of the laser light is positioned within the irradiation range of the laser light of a part of the light source units positioned at the center of the area in which the three or more light source units are arranged. Therefore, in step S110 of the optical axis adjustment processing, the light emission controller 40 is capable of detecting the center of the irradiation area of the laser light irradiated by the laser radar device 100 within the irradiation area of the laser light irradiated by the second light source unit 12 which is a part of the light source units.

According to the laser radar device 100B of the present embodiment described above, the light emission controller 40 is capable of detecting the center based on the difference in brightness of each of the different portions of the object irradiated with a part of the laser light, and thus there is no need for simultaneous detection of the entire irradiation area of the laser light. Therefore, the optical axis can be adjusted without using a large-scale apparatus.

### D. Fourth Embodiment

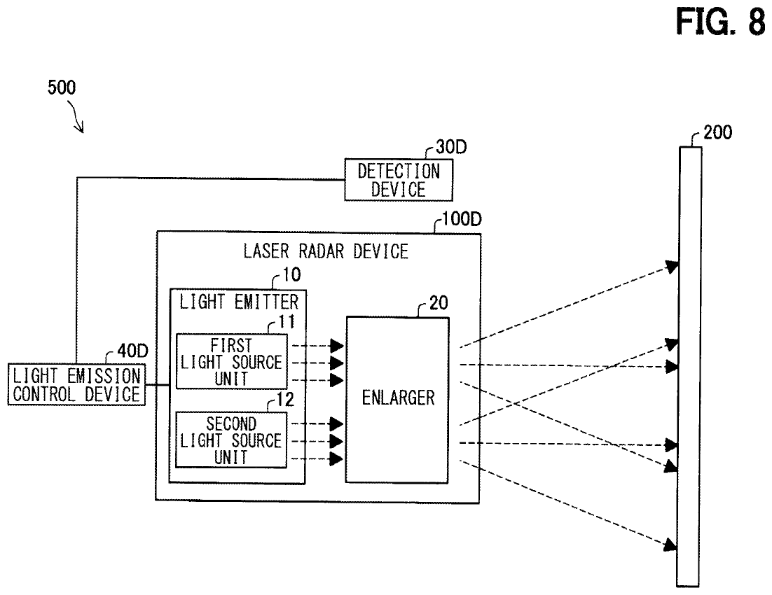

A fourth embodiment is different from the first embodiment in that a laser radar device 100D includes only a light emitter 10 and an enlarger 20. As shown in FIG. 8, an optical axis adjustment system 500 includes the laser radar device 100D, a detection device 30D (detector), and a light emission control device 40D (light emission controller). The optical axis adjustment system 500 adjusts the optical axis of the laser radar device 100D. The fourth embodiment also has substantially the same effects as the first embodiment.

### E. Other Embodiments

In the embodiment described above, the light emitter 10 includes light source units arranged in one direction, and emits a line beam. Alternatively, a light emitter 10 may have only one light source unit and emit a pencil beam. In this case, for example, a light emission controller 40 controls switching between irradiation and non-irradiation of the laser light and the light emission intensity of the laser light by covering a part of the light source unit of the light emitter 10 from which the laser light is emitted.

In the first embodiment described above, the light emission controller 40 detects the center based on the difference between the brightness of each of the different portions of the screen 200 in the first irradiation state and the brightness of each of the different portions of the screen 200 in the second irradiation state. Alternatively, a light emission controller 40 may detect the center based on a difference between the brightness of a part of the screen 200 in the first irradiation state and the brightness of another part of the screen 200 in the first irradiation state. For example, the first irradiation state is a state in which the laser light is transmitted so as to irradiate the entire irradiation area of the laser light. In this case, the light emission controller 40 detects, as the center of the irradiation area of the laser light, a position where the brightness of the object irradiated with the laser light is lower than the brightness of the surroundings, which is a gap between the irradiation areas of the first light source unit 11 and the second light source unit 12.

In the first embodiment described above, the light emission controller 40 controls the light emitter 10 to transmit the laser light while switching between irradiation of the laser light in a part of the irradiation area of the laser light and non-irradiation of at least another part of the irradiation area of the laser light, and non-irradiation of the laser light in a part of the irradiation area of the laser light and irradiation of at least another part of the irradiation area of the laser light. The present invention is not limited to this, and a light emission controller 40 may control the light emitter 10 to switch the light emission intensity of the laser light in a part of the irradiation area of the laser light and the light emission intensity in at least another part of the irradiation area of the laser light and transmit the laser light. For example, the light emission controller 40 may switch between a first irradiation state in which the first light source unit 11 emits the laser light having a first light emission intensity and the second light source unit 12 emits the laser light having a second light emission intensity by controlling the light emitter 10 to transmit the laser light and a second irradiation state in which the first light source unit 11 emits the laser light having the second light emission intensity and the second light source unit 12 emits the laser light having the first light emission intensity by controlling the light emitter 10 to transmit the laser light.

In the third embodiment described above, the light emitter 10 includes three light source units, that is, the first light source unit 11, the second light source unit 12, and the third light source unit 13 arranged in one direction. Alternatively, a light emitter 10 may include four or more light source units arranged in one direction. In the case where a light emitter 10 has an even number of light source units, the irradiation step and the center detection step may be performed using the two light source units at a middle area among the plurality of light source units arranged in one direction and without using the other light source units located at the end portions. In addition, when the light emitter 10 includes an odd number of light source units, the irradiation step and the center detection step may be performed using a light source unit at a central portion of a plurality of light source units arranged in one direction without using other light source units located at end portions.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

The controller and the method described in the present disclosure may be implemented by a special purpose computer which is configured with a memory and a processor programmed to execute one or more particular functions embodied in computer programs of the memory. Alternatively, the controller and the method described in the present disclosure may be implemented by a special purpose computer configured as a processor with one or more special purpose hardware logic circuits. Alternatively, the controller and the method described in the present disclosure may be implemented by one or more special purpose computer, which is configured as a combination of a processor and a memory, which are programmed to perform one or more functions, and a processor which is configured with one or more hardware logic circuits. The computer programs may be stored, as instructions to be executed by a computer, in a tangible non-transitory computer-readable medium.

What is claimed is:

1. An optical axis adjustment method for adjusting an optical axis direction of a laser radar device, the method comprising:
irradiating an object with laser light emitted from the laser radar device by controlling the laser radar device to cause a difference in brightness in each of different portions of the object;
detecting a center of an irradiation area on the object irradiated with the laser light based on the difference in brightness of each of the different portions of the object irradiated with the laser light emitted from the laser radar device; and
adjusting the optical axis direction of the laser radar device such that the center detected in the detecting is at a predetermined position relative to the laser radar device.

2. The optical axis adjustment method according to claim 1, wherein
the irradiating includes switching between first irradiating and second irradiating to cause the difference in brightness of each of the different portions of the object,
the first irradiating is irradiating one part of the irradiation area with the laser light without irradiating at least another part of the irradiation area with the laser light, and
the second irradiation state is a state where the one part of the irradiation area is not irradiated with the laser light and at least the other part of the irradiation area is irradiated with the laser light.

3. The optical axis adjustment method according to claim 1, wherein
the irradiating includes emitting the laser light to cause the difference in brightness of each of the different portions of the object such that the irradiation area includes a portion irradiated with the laser light having a first light emission intensity and a portion irradiated with the laser light having a second light emission intensity different from the first light emission intensity.

4. The optical axis adjustment method according to claim 1, wherein
the laser radar device includes three or more light source units configured to emit laser light, respectively, on irradiation areas arranged in one direction,
the irradiating includes emitting the laser light using a part of the light source units that emits the laser light on an area corresponding to a center of a range in which the three or more light source units arranged in the one direction without using other light source units that emit the laser light on areas corresponding to ends of the range, and
the detecting includes detecting the center of the irradiation area within an irradiation area on the object irradiated with the laser light emitted by the part of the light source units.

5. A laser radar device comprising:
a light emitter configured to emit laser light;
an enlarger configured to enlarge a beam diameter of the laser light emitted by the light emitter;
a detector configured to detect brightness of each of different portions of the object irradiated with the laser light enlarged by the enlarger; and
a light emission controller configured to control the light emitter, wherein
the light emission controller is configured to
irradiate an object with the laser light emitted by the from the laser radar device by controlling the light emitter to cause a difference in brightness of each of different portions of the object,
detect a center of an irradiation area on the object irradiated with the laser light based on the difference in brightness detected by the detector, and
adjust an optical axis direction of the light emitter such that the detected center is at a predetermined position relative to the laser radar device.

6. An optical axis adjustment system, comprising:
a laser radar configured to emit laser light;
a detector configured to detect brightness of each of different portions of an object irradiated with the laser light; and
a light emission controller configured to control the laser light of the laser radar device, wherein
the light emission control device is configured to
control the laser radar device to emit the laser light to cause a difference in brightness of each of different portions of the object irradiated with the laser light emitted from the laser radar device,
detect a center of an irradiation area on the object irradiated with the laser light based on the difference in brightness detected by the detection device, and
adjust an optical axis direction of the laser radar device such that the detected center is at a predetermined position with respect to the laser radar device.
